(19) United States
(12) Patent Application Publication
(10) Pub. No.: US 2015/0168878 A1
(43) Pub. Date: Jun. 18, 2015

(54) IMAGE FORMING APPARATUS

(71) Applicant: CANON KABUSHIKI KAISHA, Tokyo (JP)

(72) Inventors: Toru Imaizumi, Kawasaki-shi (JP); Takashi Narahara, Mishima-shi (JP); Atsutoshi Ando, Yokohama-shi (JP); Yasuhito Minamishima, Odawara-shi (JP)

(21) Appl. No.: 14/568,716

(22) Filed: Dec. 12, 2014

(30) Foreign Application Priority Data
Dec. 12, 2013 (JP) 2013-256851

(51) Int. Cl. G03G 15/00

(52) U.S. Cl. CPC G03G 15/1605

(57) ABSTRACT

An image forming apparatus for forming an image on a recording material includes: a contact member, contacting the recording material, to which a voltage to be applied; a first electroconductive member contacting the recording material downstream of the contact member with respect to a recording material feeding direction, wherein the first electroconductive member is grounded; and a second electroconductive member contacting the recording material. A distance between the contact member and the first electroconductive member is not more than a length of a longest recording material capable of being fed by the image forming apparatus. A contact resistance between the second electroconductive member and the recording material is smaller than a contact resistance between the first electroconductive member and the recording material. The first and the second electroconductive member are electrically connected in parallel to each other.

### FIELD OF THE INVENTION AND RELATED ART

The present invention relates to an image forming apparatus, of an electrophotographic type, including a transfer portion for electrostatically transferring an unfixed toner image, formed on an image bearing member, onto a fed recording material and including a fixing device for fixing the (unfixed) toner image, transferred on the recording material, as a fixed image on the recording material.

In the image forming apparatus, such as a copying machine or an LBP, of the electrophotographic type, the toner image formed, with a charged toner (visualizing material), on an image bearing member such as a photosensitive member or an intermediary transfer member is electrostatically transferred onto a recording material. Then, the recording material and the toner image are heated and fixed as the fixed image by the fixing device to perform a printing (image forming) operation.

At a transfer portion, a high voltage is applied to the recording material via a transfer member, and therefore the recording material is electrically charged. When the recording material is discharged onto a discharge tray (discharge portion) outside the apparatus while being charged, there is a liability that the discharged recording materials are electrostatically attracted to or repelled by each other, and thus problems of a lowering in alignment (orientation) property of the recording materials on the discharge tray and drop of the recording material from the discharge tray generates.

Therefore, in a conventional image forming apparatus a discharging (charge-removing) member formed with stainless steel, a carbon brush or the like has been provided in the neighborhood of a recording material exit port so as to contact the recording material to be discharged. An end of such a discharging member is grounded, so that removal of electric charges which existed on the surface of the recording material has been made.

In Japanese Laid-Open Patent Application (JP-A) 2003-233261, a technique in which a discharging brush is provided downstream of a fixing nip with respect to a recording material feeding direction and the recording material is brought into contact with the discharging brush in a state in which the recording material is sandwiched in the nip has been disclosed. In this technique, the electric charges existing on the recording material are removed by bringing the discharging member into contact with the recording material after an end of the fixing. As a result, the alignment property when the recording materials are discharged on the discharge tray can be improved.

However, in the case of an image forming apparatus in which a distance from a transfer portion to a discharging portion is short a status in which a trailing end portion of the recording material is subjected to toner image transfer at the transfer portion, and at the same time, a leading end portion of the recording material is subjected to discharge (charge removal) by the discharging member can generate. As a result, when paper such as glossy paper which is low in resistance is passed through the transfer portion in a high-temperature and high-humidity environment, there is a possibility that an electrostatic attraction force acts between the recording material and the discharging member by the influence of a bias (voltage) from the transfer portion, and thus the discharging member strongly runs against the recording material to generate a stripe image defect.

### SUMMARY OF THE INVENTION

According to an aspect of the present invention, there is provided an image forming apparatus for forming an image on a recording material, comprising: a contact member, contacting the recording material, to which a voltage is to be applied; a first electroconductive member contacting the recording material downstream of the contact member with respect to a recording material feeding direction, wherein the first electroconductive member is grounded; and a second electroconductive member contacting the recording material, wherein a distance between the contact member and the first electroconductive member is not more than a length of a longest recording material capable of being fed by the image forming apparatus, wherein a contact resistance between the second electroconductive member and the recording material is smaller than a contact resistance between the first electroconductive member and the recording material; and wherein the first electroconductive member and the second electroconductive member are electrically connected in parallel to each other.

According to another aspect of the present invention, there is provided an image forming apparatus for forming an image on a recording material, comprising: a contact member, contacting the recording material, to which a voltage is to be applied; a discharging brush contacting the recording material downstream of the contact member with respect to a recording material feeding direction, wherein the discharging brush is grounded; and a roller contacting the recording material, wherein a distance between the contact member and the is not more than a length of a longest recording material capable of being fed by the image forming apparatus, and wherein the discharging brush and the roller are electrically connected in parallel to each other.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view for illustrating an electric connection form and action of a discharging brush in Embodiment 1.

FIG. 2 is a schematic view for illustrating a structure of an image forming apparatus in Embodiment 1.

FIG. 3 is a block diagram of a control system.

FIG. 4 is a partly enlarged schematic view of FIG. 2.

FIG. 5 is a schematic view for illustrating an electric connection form and action of a discharging brush in Embodiment 2.

FIG. 6 is a schematic view for illustrating an electric connection form and action of a discharging brush in Embodiment 3.

FIG. 7 is a schematic view for illustrating an electric connection form and action in a reference example.

### DESCRIPTION OF THE EMBODIMENTS

Embodiments of the present invention will be described below with reference to the drawings. First, a summary of an image forming apparatus and a fixing device in an embodiment will be described and then a (characteristic) feature of the embodiment will be described.

### Embodiment 1

In the following description of an apparatus (device) structure, a longitudinal direction refers to a direction perpendicular to a recording material feeding direction in a recording material feeding path.

### (Image Forming Apparatus)

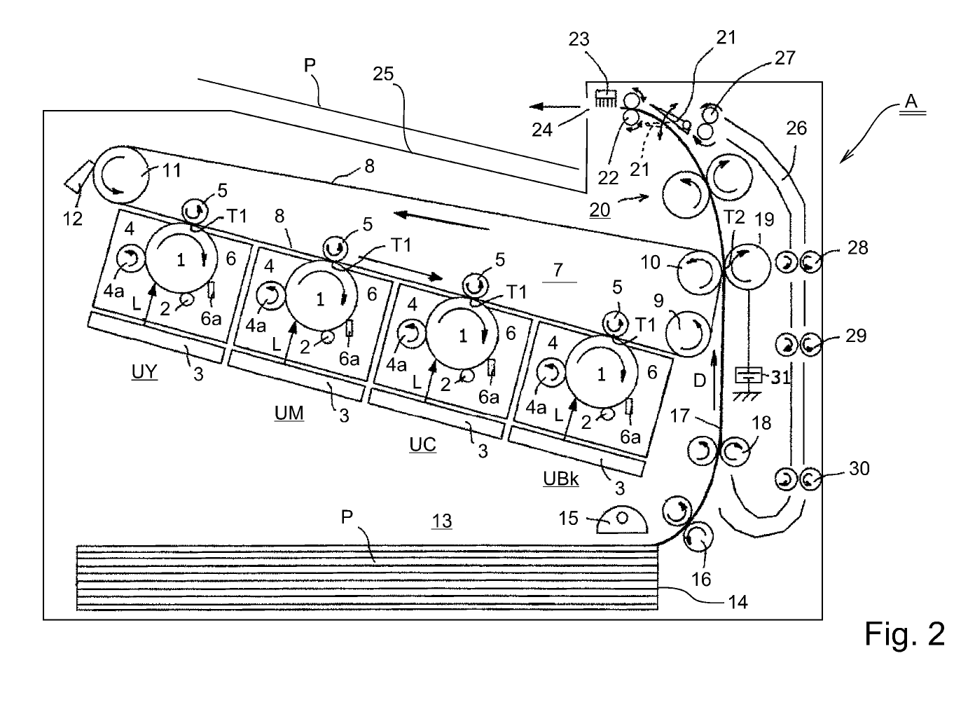

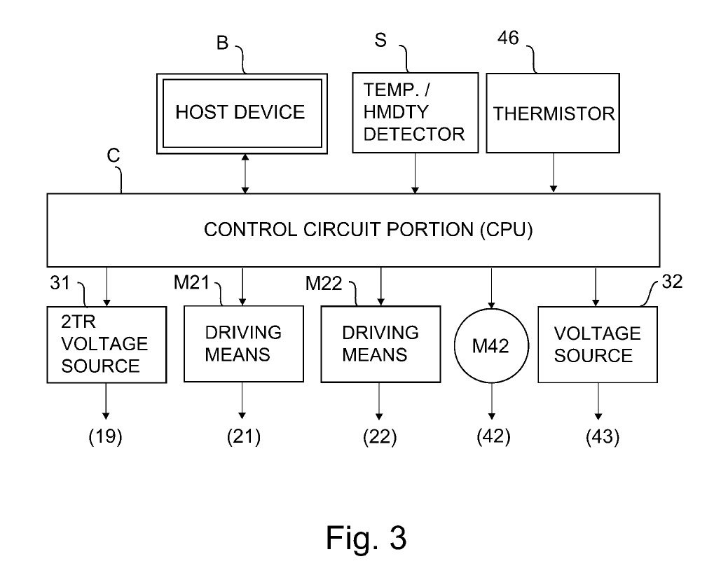

FIG. 2 is a schematic sectional view of an image forming apparatus A in this embodiment as seen from a direction perpendicular to the longitudinal direction of the image forming apparatus A, and FIG. 3 is a block diagram of a control system. This image forming apparatus is a four-color based full-color laser printer of an intermediary transfer belt type using an electrophotographic process. That is, the image forming apparatus A carries out an image forming operation on a sheet-like recording material (hereinafter referred to as a sheet) on the basis of an electric image signal inputted from an external host device B, such as a personal computer, an image reader or a remote facsimile machine, into a control circuit portion C.

First to Fourth image forming portions U (UV, UM, UC, UBk) have an in-line structure (tandem type). The image forming portions U are electrophotographic process units having the same constitution except that developing colors are different from each other.

That is, each of the image forming portions U includes a photosensitive drum 1, as a first image bearing member, having a photosensitive layer, and includes, as process means actable on the drum 1, a charging means 2, an exposure means 3, a developing means 4, a primary transfer means 5, a cleaning means 6 and the like. In this embodiment, the charging means 2 is a charging roller. The exposure means is a laser scanner. The primary transfer means 5 is a transfer roller. The cleaning means 6 includes a cleaning blade 6a and a residual toner container.

The developing means 4 includes a developing roller 4a, and a developer (toner) is accommodated in a developer container. In the developer container of the developing means 4 at the first image forming portion UY, as the developer, the toner of yellow (Y) is accommodated. In the developer container of the developing means 4 at the second image forming portion UM, as the developer, the toner of magenta (M) is accommodated. In the developer container of the developing means 4 at the third image forming portion UC, as the developer, the toner of cyan (C) is accommodated. In the developer container of the developing means 4 at the fourth image forming portion UBk, as the developer, the toner of black (Bk) is accommodated.

At an upper portion of the first to fourth image forming portions UY, UM, UC and UBk, an intermediary transfer belt unit 7 is provided. The belt unit 7 includes an endless transfer belt 8, as a second image bearing member, which is formed of a dielectric material and which has flexibility. The belt unit 7 further includes, as a plurality of belt supporting members for stretching the transfer belt 8, a driving roller 9, a secondary transfer opposite roller 10 and a tension roller 11.

The primary transfer roller 5 at each image forming portion U is provided inside the transfer belt 8, and contacts a lower-side belt portion, toward an upper surface portion of the associated drum 1, at a potential between the driving roller 9 and the tension roller 11. At each image forming portion U, a contact portion between the drum 1 and the transfer belt 8 is a primary transfer nip T1. Toward the secondary transfer opposite roller 10, a secondary transfer roller 19 contacts the transfer belt 8. A contact portion between the transfer belt 8 and the secondary transfer roller 19 is a secondary transfer nip N2. At a belt contact portion of the tension roller 11, a belt cleaning device 12 is provided.

Below the first to fourth image forming portions UY, UM, UC and UBk, a sheet feeding unit 13 is provided. The sheet feeding unit 13 includes a sheet feeding cassette 14, a semicircular sheet feeding roller 15 and a separation roller pair (retard roller mechanism) 16. A vertical sheet feeding path 17 extending from the separation roller pair 16 to a sheet discharging opening 24 at the upper portion of the image forming apparatus A is provided. Along this vertical sheet feeding path 17, from a lower side toward an upper side, a registration roller pair 18, the secondary transfer roller 19, a fixing device 20, a flapper 21, a discharging roller pair 22 and a discharging brush 23 are successively provided. An upper surface portion of the image forming apparatus constitutes a discharge tray 25.

In an opposite side to the belt unit 7 side with respect to the vertical sheet feeding path 17, a feeding path 26 for returning and feeding a sheet P from a flapper 21 to the registration roller pair 18 to perform double-side printing is provided. Along this feeding path 26, a plurality of feeding roller pairs 27 to 30 for double-side printing are provided.

An operation for forming a full-color image is as follows. At predetermined control timing, the drums 1 of the first to fourth image forming portions U are rotationally driven at a predetermined contact speed in the clockwise direction indicated by arrows. The transfer belt 8 is rotationally driven at a speed corresponding to the speed of the drums 1 in the counterclockwise direction indicated by allows.

At each image forming portion U, at predetermined control timing, the charging roller 2 electrically charges uniformly the surface of the drum 1 to a predetermined polarity and a predetermined potential. The scanner 3 subjects the surface of the drum 1 to scanning exposure with laser light L modulated depending on an image signal for the associated color. As a result, an electrostatic latent image depending on the image signal for the associated color is formed on the surface of the drum 1. The formed electrostatic latent image is developed into a toner image by the developing means 4.

By the above-described electrophotographic process operation, a Y toner image corresponding to a Y component of a full-color image is formed on the drum 1 of the first image forming portion UY, and then is predetermined-transferred onto the belt 8. An M toner image corresponding to an M component of the full-color image is formed on the drum 1 of the second image forming portion UM, and then is predetermined-transferred superposedly onto the Y toner image which has already been transferred on the belt 8. An C toner image corresponding to a C component of the full-color image is formed on the drum 1 of the third image forming portion UC, and then is predetermined-transferred superposedly onto the Y and M toner images which has already been transferred on the belt 8. An Bk toner image corresponding to a Bk component of the full-color image is formed on the drum 1 of the fourth image forming portion UBk, and then is predetermined-transferred superposedly onto the Y, M and C toner images which has already been transferred on the belt 8.

At each image forming portion U, the primary transfer of the toner image from the drum 1 onto the transfer belt 8 is made by the associated primary transfer roller 5 to which a predetermined primary transfer voltage is applied. As a result, on the belt 8, a full-color (unfixed) toner image based on the four colors of Y, M, C and Bk is synthetically formed. At each image forming portion U, a transfer residual toner remaining on the surface of the drum 1 after the primary transfer of the toner image onto the belt 8 is removed by the cleaning means 6.

On the other hand, at predetermined control timing, the sheet feeding roller 15 is driven. As a result, the sheet P stacked and accommodated in the sheet feeding cassette 14 is fed and separated by the separation roller pair 16 in a one-by-one manner to enter the feeding path 17, and then is fed upwardly along the feeding path 17. That is, the sheet P is fed in a sheet feeding direction (recording material feeding direction) D. The sheet P is fed to the registration roller pair 18 and thus is once stopped by the registration roller pair 18. Then, in synchronism with timing when the toner image formed on the transfer belt 8 reaches the secondary transfer nip T2, the sheet P which has been once stopped is fed by the registration roller pair 18 and then is introduced into the secondary transfer nip T2 again.

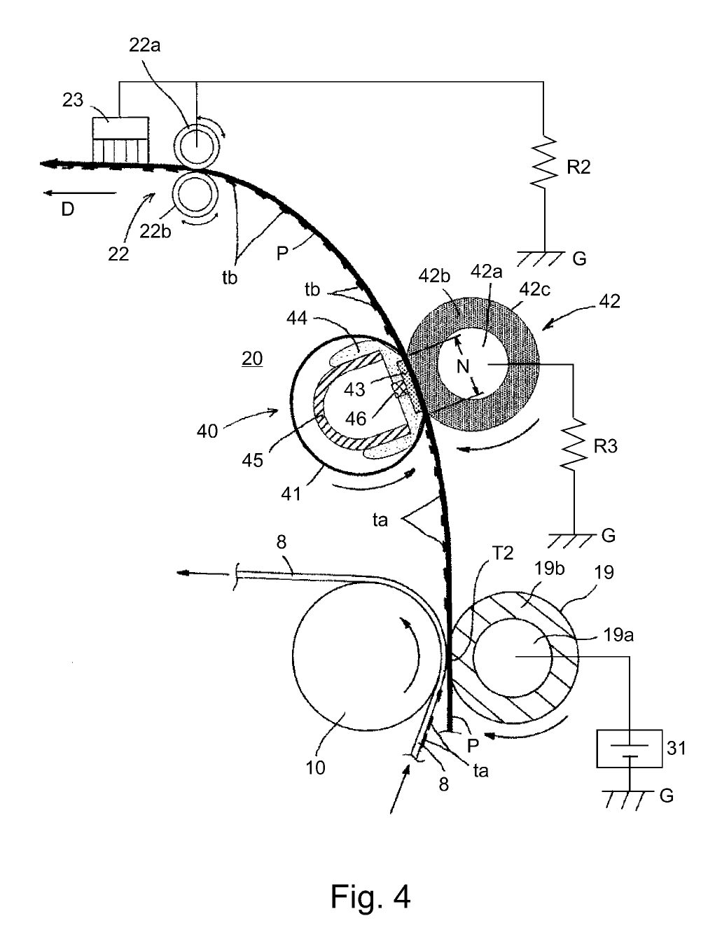

As a result, (unfixed) toner images to (FIG. 4) consisting of superposed four color toner images on the transfer belt 8 are collectively transferred successively onto the surface of the sheet P in a process in which the sheet P is nipped and fed through the secondary transfer nip T2. This secondary transfer is made by applying a secondary transfer voltage, controlled in a predetermined manner, from a secondary transfer voltage source 31 to the secondary transfer roller 19.

The sheet P coming out of the secondary transfer nip T2 is separated from the surface of the transfer belt 8 and introduced into the fixing device 20, and then is heated and pressed in a fixing nip N (FIG. 4). As a result, color mixing and fixing of the respective color toner images, as fixed images tb (FIG. 4), on the sheet P. Then, the sheet P comes out of the fixing device 20 passes below a flapper 21 switched into a first attitude indicated by a solid line in FIG. 2 and is sandwiched between the discharging roller pair 22, and thereafter is discharged as a full-color image-formed product (in the case of one-side image forming method) on the discharge tray 25 through the discharging opening 24.

When the sheet P is discharged on the discharge tray 25, a non-printing surface (back surface) of the sheet P is fed while contacting a discharging brush 23 as a contact discharging member provided between the discharging opening 24 and the discharging roller pair 22, so that electric charges remaining on the sheet P are removed. As a result, an alignment property when the sheets P are discharged onto the discharge tray 25 can be improved. A secondary transfer residual toner remaining on the transfer belt 8 without being transferred on the sheet P in the secondary transfer of the toner image from the transfer belt 8 onto the sheet P is removed and collected by the belt cleaning device 12.

In the case where the image formation on the sheet P is one-side (surface) printing, the sheet P on which the image is fixed by the fixing device 20 is discharged onto the discharge tray 25 by the sheet discharging roller pair 22, so that the image formation is ended. In the case of multi-printing of a plurality of sheets to be continuously fed, the above image forming is repetitively performed.

On the other hand, in the case where the image formation of the sheet P is made on the both sides (surfaces) (double-side image forming mode), the control circuit portion C controls a driving means M22 at timing when a trailing end portion of the sheet P on which the image is formed at one surface and which is then sent from the fixing device 20 reaches the discharging roller pair 22, thus reversely rotating the discharging roller pair 22. As a result, the sheet P is switch-back-fed from the discharge tray 25 side into the image forming apparatus. Further, the control circuit portion C controls a driving means M21 to switch the flapper 21 from the first attitude indicated by the solid line into a second attitude indicated by a broken line.

The sheet P switch-back-fed by the reverse rotation of the discharging roller pair 22 passes through the upper surface of the flapper 21 switched into the second attitude and is introduced into the feeding path 26 for double-side printing. Then, the sheet P is fed in the feeding path 26 by fixing roller pairs 27, 28, 29 and 30 and then is fed to the registration roller pair 18 in an upside down state, and thereafter is fed again to the secondary transfer nip T2 at predetermined timing. As a result, the sheet P is subjected to secondary transfer of the toner image on the second surface (back surface).

Thereafter, similarly as in the case of the one-side image forming mode, the sheet P passes through the path including the lower surface side of the flapper 21, the discharging roller pair 22 returned to the normal rotation and the discharging opening 24, and then is discharged as a double-side image-formed product onto the discharge tray 25. When the sheet P on which the image is formed in both sides is discharged onto the discharge tray 25, the first surface of the sheet P is fed while contacting the discharging brush 23, so that the electric charges remaining on the sheet P are removed (discharged). As a result, the alignment property when the sheets P are discharged onto the discharge tray 25 can be improved.

In the case of the multi-printing of the plurality of continuous sheets in the double-side image forming mode, the above-described image forming operation is repetitively performed.

FIG. 4 is an enlarged schematic view of a portion, of the image forming apparatus of FIG. 4, where the secondary transfer nip T2, the fixing device 20, the discharging roller pair 22 and the discharging brush 23 are disposed. In this embodiment, as the secondary transfer roller 19, a roller which is 18 mm in outer diameter and which is prepared by coating a nickel-plated steel rod 19a of 8 mm in outer diameter with a foam sponge member 19b, formed principally of NBR and epichlorohydrin, adjusted to have a volume resistivity of 10⁸ Ω·cm and a thickness of 5 mm

A secondary transfer voltage source 31 is electrically connected from a transducer (not shown) is supplied to the secondary transfer roller (contact member) 19. The secondary transfer voltage is controlled at a substantially constant level by CPU which is a control IC of the image forming apparatus in a manner such that a difference between a preset control voltage and a monitor voltage which is an actual output value. The secondary transfer voltage source 31 is capable of outputting the voltage in a range from 100 (V) to 4000 (V). The image forming apparatus A is provided with a temperature and humidity detecting portion S and determines a transfer voltage depending on an environment and a print mode.

### (Fixing Device)

In this embodiment, as an example of the fixing device 20, the fixing device of the film fixing type is used. However, the fixing device 20 may also be a fixing device of another type such as a heating roller type. With reference to FIG. 4, the fixing device 20 in this embodiment roughly includes a film unit 40, a pressing roller 42 as a pressing member (opposing member, nip-forming member) and a device casing (not shown).

The film unit 42 includes a flexible cylindrical film (first member) 41, a plate-like heater 43 contacting an inner surface of the film 41, a supporting member 44 for supporting the heater 43, and a pressing stay 45 for reinforcing the supporting member 44. The film 41 is loosely fitted externally around an assembly of the heater 43, the supporting member 44 and the pressing stay 45.

The film 41 is a cylindrical flexible member including a base layer, an elastic layer formed outside the base layer and a parting layer formed outside the elastic layer. The film 41 in this embodiment is 18 mm in inner diameter, and as the base layer, a 60 μm-thick polyimide base material is used. As the elastic layer, an abut 150 μm-thick silicone rubber layer is used, and as the parting layer, a 15 μm-thick PFA resin tube is used.

The supporting member 44 is a member having rigidity, heat-resistant property and heat-insulating property, and is formed of a liquid crystal polymer. The supporting member 44 has the function of supporting the inner surface of the film 41 externally fitted around the supporting member 44 and the function of supporting one surface of the heater 43.

The heater 43 is formed by coating an alumina substrate with a heat-generating resistor of silver-palladium alloy by screen printing or the like and then by connecting the heat-generating resistor with an electric contact portion of silver or the like. On the heat-generating resistor, glass coat as a protective layer is formed to protect the heat-generating resistor, so that a sliding property with the film 41 is improved. The alumina substrate of the heater 43 in this embodiment is 5.8 mm in length with respect to a sheet feeding direction and 1.0 mm in thickness. On the inner surface of the film 41, grease having the heat-resistant property is applied, so that the sliding property of the film 41 is improved. On the back surface of the heater 43, a thermistor 46 is mounted.

The pressing stay 45 has a U-shape in cross section in order to enhance flexural rigidity, and is formed by bending a 1.6 mm-thick stainless steel plate.

The pressing roller (second member) 42 is an electroconductive roller including a core metal 42a, an elastic layer 42b formed outside the core metal 42a, and a parting layer 42c formed outside the elastic layer 42b. As a material for the elastic layer 42b, silicone rubber, fluorine-containing rubber or the like is used. As a material for the parting layer 42c, a fluorine-containing resin material such as PFA (tetrafluoroethylene-perfluoroalkylvinyl ether copolymer) is used.

In this embodiment, as the pressing roller 42, a roller which is 18 mm in outer diameter and which is prepared by forming an about 3.5 mm-thick silicone rubber layer 42b on a stainless steel-made more metal 42a of 11 mm in outer diameter by injection molding and then by coating an outside of the layer 42b with an about 40 μm-thick PFA resin tube 42c was used. An electroconductive carbon filler is added into the silicone rubber layer 42b and the PFA resin tube 43c of the pressing roller 42, so that an actual resistance between the core metal 42a as a roller and the surface layer 42c is about 10 kΩ.

The film unit 40 and the pressing roller 42 are disposed so that the heater 43 opposes the pressing roller 42 via the film 41. The pressing roller 42 is rotatably supported by the device casing via a bearing member at each of longitudinal end portions of the core metal 42a. Further, the heater of the film unit 40 is pressed against film 41 toward the pressing roller 42 by the pressing stay 45 and the supporting member 44, so that the film N of about 6.2 mm in width is formed with respect to the sheet (recording material direction. In this embodiment, the pressure between the film 41 and the pressing roller 42 is 180 N in total pressure.

A hardness of the pressing roller 42 may desirably be, from the viewpoints of entering of the fixing nip N and durability, in a range of 40-70 degrees as measured by an Asker-C hardness meter under a load of 9.8 N. In this embodiment, the hardness is 54 degrees.

The fixing device 20 in this embodiment includes the first member and the second member which form the fixing nip N. The film 41 corresponds to the first member, and the pressing roller 42 corresponds to the second member.

During an operation of the fixing device 20, a rotational force is transmitted from the driving means M42 controlled by the control circuit portion C to a driving gear (not shown) provided in one side of the core metal 42a of the pressing roller 42, so that the pressing roller 42 is rotationally driven in the clockwise direction indicated by an arrow at a predetermined speed. The rotational force acts on the cylindrical film 41 by a contact frictional force at the fixing nip N between the roller 42 and the outer surface of the film 41, generated by the rotational drive of the pressing roller 42. As a result, the film 41 is rotated around the supporting member 44 and the pressing stay 45 in the counterclockwise direction indicated by an arrow while intimately sliding on the surface of the heater 43 at the inner surface of the film 41 in the fixing nip N.

Further, energization from the voltage source portion 32 controlled by the control circuit portion C to the heat generating resistor of the heater 43 is made. As a result, the heat generating resistor generates heat, so that an effective heating region along a longitudinal direction of the heater abruptly increases in temperature. Then, a heater temperature is detected by the thermistor 46 provided on the back surface of the heater, and heater temperature detection information is fed back to the control circuit portion C. The control circuit portion C controls the voltage source portion 32 on the basis of the heater temperature detection information fed back from the thermistor 46 to control electric power supplied to the heat generating resistor so that the heater temperature is controlled and maintained at a predetermined target temperature.

In this way, in a state in which the film 41 is rotated by the rotational drive of the pressing roller 42 and in which the heater 46 is increased in temperature by the energization to the heater 46 and thus is temperature-controlled at the predetermined target temperature, the sheet P on which the toner image ta is carried is introduced into the fixing nip N. Then, the surface of the sheet P on which the toner image ta is carried is closely contacted to the film 41 is fed together with the film 41 through the fixing nip N. In this feeding process, the toner image ta on the sheet P is heated and pressed on the sheet P, and is fixed as the fixed image tb.

The sheet P passed through the fixing nip N is curvature-separated from the surface of the film 41 and then is discharged onto the discharge tray 25 outside the apparatus through the discharging opening by the sheet discharging roller pair 22. When the sheet P is discharged through the discharging opening, a non-printing surface (back surface: first surface in the case of double-side image forming mode) of the sheet P contacts the discharging brush 23 provided between the discharging roller pair 22 and the discharging opening 24. In this embodiment, as the discharging brush 23, an electric discharging brush prepared by fixing stainless steel string with a metal tape having electroconductivity.

A sheet feeding path length (recording material path length) from the transfer portion T2 to the discharging brush 23 is not more than a maximum length of the sheet usable in the image forming apparatus. In this embodiment, a distance from the secondary transfer portion T2 to the fixing nip N is 50 mm, and a distance from the fixing nip N to the discharging brush 23 is 70 mm, so that a total length is 120 mm. For that reason, when the sheet P having an ordinary A4 size or letter size is passed through the transfer portion T2, in the trailing end side of the sheet P, the toner image t is transferred onto the sheet P by the secondary transfer roller 19, and at the same time, in the leading end side of the sheet P, the electric charges are removed by the discharging brush 23.

### Problem of this Embodiment

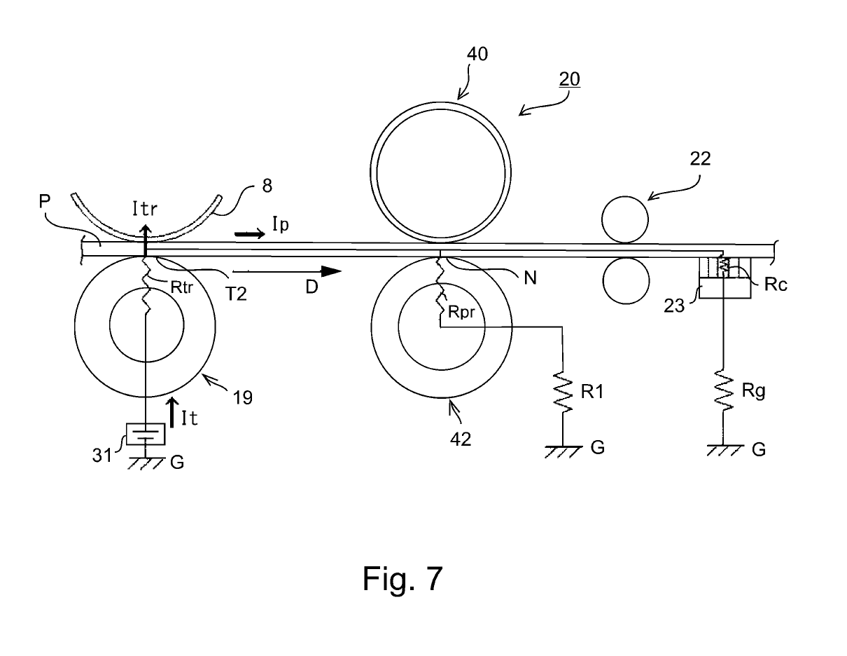

A problem of this embodiment will be described with reference to FIG. 7. FIG. 7 is a schematic view of a part of an image forming portion in an example of the electrophotographic image forming apparatus of the intermediary transfer type.

On the surface of the intermediary transfer belt 8 as the image bearing member, the (unfixed) toner image formed with the toner electrically charged by an unshown electrophotographic process mechanism portion is formed. The transfer roller 19 as the secondary transfer member contacts the transfer belt 8 to form the secondary transfer nip (transfer portion) T2. The recording material P is introduced into the transfer portion T2 and is nipped and fed, so that the toner images are electrostatically transferred successively from the surface of the transfer belt 8 onto the surface of the recording material P. The toner image transfer is made by applying the transfer voltage from the transfer voltage source 31 to the transfer roller 19.

The recording material P coming out of the transfer portion T2 enters the fixing device 20 for fixing the toner image as the fixed image. The fixing device 20 includes the fixing film unit 40 and the pressing roller 42 which form the fixing nip N where the recording material P is nipped and fed to heat-fix the toner image. The fixing film unit 40 contacts the toner image carrying surface of the recording material P. The pressing roller 42 contacts the surface opposite from the toner image carrying surface of the recording material P.

The recording material P coming out of the recording material P is relayed to the discharging roller pair 22 to be fed and discharged. In the downstream side of the discharging roller pair 22 with respect to a recording material feeding direction D, the discharging brush 23 as the discharging member is provided. The recording material P relayed by the discharging roller pair 22 to be fed and discharged is fed and discharged while contacting the discharging brush 23 at the back surface (opposite from the image-formed surface) thereof, so that the electric charged remaining on the recording material P are removed. As a result, the alignment property when the recording material P is discharged onto the discharge portion (not shown) can be improved.

In FIG. 7, a distance from the transfer portion to the discharge portion is designed to be short in order to realize downsizing of the image forming apparatus and shortening of a first print out time. For that reason, there can arise a status such that the recording material P is subjected to the toner image transfer at the transfer portion T2 in the trailing end side and is simultaneously subjected to the charge removal by the discharging brush 23 in the leading end side.

In a high-temperature and high-humidity environment, in accordance with the voltage applied from the transfer voltage source 31 to the secondary transfer roller 19, a predetermined transfer current Itr passes through the transfer portion T2. Further, the recording material P left standing in an environment of the high temperature and the high humidity is low in resistance, so that the current not only flows in the direction toward the transfer belt 8 but also partly flows through the recording material P as a leak current Ip.

When the leak current Ip is excessively large, improper transfer is caused to generate at the transfer portion T2. For that reason, in the case where the electroconductive member is grounded, there is a need to insert a grounding resistor which is high in resistance to some extent. Therefore, as the grounding resistor of the pressing roller 42 of the fixing device 20, a resistor R1 is provided.

With a lower resistance of the recording material P, a voltage drop from the transfer portion T2 less generate, and therefore the potential of the recording material P in the neighborhood of the discharging brush 23 becomes high at the same level as the surface potential of the secondary transfer roller 19. On the other hand, the discharging brush 23 itself is formed with the electroconductive member, but a free end thereof point-contacts the recording material P, and therefore a contact resistance Rc is 1 GΩ or more which is very large.

The contact resistance Rc between the recording material P and the discharging brush 23 is very large, and therefore when a constitution in which the discharging brush 23 is simply grounded (G) via a grounding resistor Rg as shown in FIG. 7 is employed, the voltage is principally shared by the contact resistance portion Rc. That is, the voltage is applied to a minute region between the recording material P and the end of the discharging brush 23, and therefore a very large electric field is applied to the minute region, so that the electrostatic attraction force acts between the recording material P and the end of the discharging brush 23.

In the one-side image forming mode (one-side printing, one-side sheet passing), the surface where the discharging brush 23 contacts the recording material P is the non-printing surface (back surface of the recording material), and therefore there is no problem even when the surface of the recording material P is rubbed with the discharging brush 23. However, in the case of the double-side image forming mode (double-side printing, double-side sheet passing), the toner image has already been formed on the surface (first surface) where the discharging brush 23 contacts the recording material P. Then, when the toner image on the second surface of the recording material P is fixed, also the toner image which has already been fixed on the first surface is melted again to some extent, and therefore there is a possibility that the discharging brush 23 is strongly rubbed with the discharging brush 23 and thus a stripe-shaped image defect generates in the image on the first surface of the recording material P.

### Feature of this Embodiment

A feature for solving the above problem will be described. The electroconductive member 22a (second electroconductive member) contacting the sheet (recording material) P fed along the sheet (recording material) feeding path from the transfer portion T2 to the discharging brush 23 (first electroconductive member) is provided and is electrically connected with the discharging brush 23 in parallel to each other. In this embodiment, the discharging roller pair 22 includes an upper sheet discharging roller 22a and a lower sheet discharging roller 22b, and the upper sheet discharging roller 22a also functions as the electroconductive member. Further, the case metal of the upper sheet discharging roller 22a and the discharging brush 23 are electrically connected with each other, and are grounded via a resistor R2. A resistance value of the resistor R2 is 500 MΩ.

The upper sheet pressing roller 22a as the electroconductive member (second electroconductive member) is an electroconductive straight roller which is long with respect to a longitudinal direction, and is prepared by forming an 1 mm-thick electroconductive elastic layer on the core metal of 4 mm in diameter. An outer diameter of the upper sheet discharging roller 22a is 6 mm. The upper sheet discharging roller 22a has an actual resistance value of about 1 kΩ between the core metal and the roller surface.

The lower sheet discharging roller 22b is prepared by forming a 1 mm-thick elastic layer on a core metal of 4 mm in diameter and then by forming an insulating PFA resin tube on the elastic layer. The lower sheet discharging roller 22b is provided in a direction toward the upper sheet discharging roller 22a by a spring (not shown), so that a nip of about 1 mm is formed between the upper and lower sheet discharging rollers 22a and 22b.

Further, in order to suppress the leak current Ip of the transfer current Itr described with reference to FIG. 7, also in this embodiment, a resistor R3 of 1 GΩ in resistance value is provided as a contact resistance for the pressing roller 42 of the fixing device 20.

The action of this embodiment is such that the electrostatic attraction force acting between the sheet P and the discharging brush 23 is decreased by reducing a potential difference between the sheet P and the discharging brush 23 and thus the generation of the stripe-shaped image defect is suppressed.

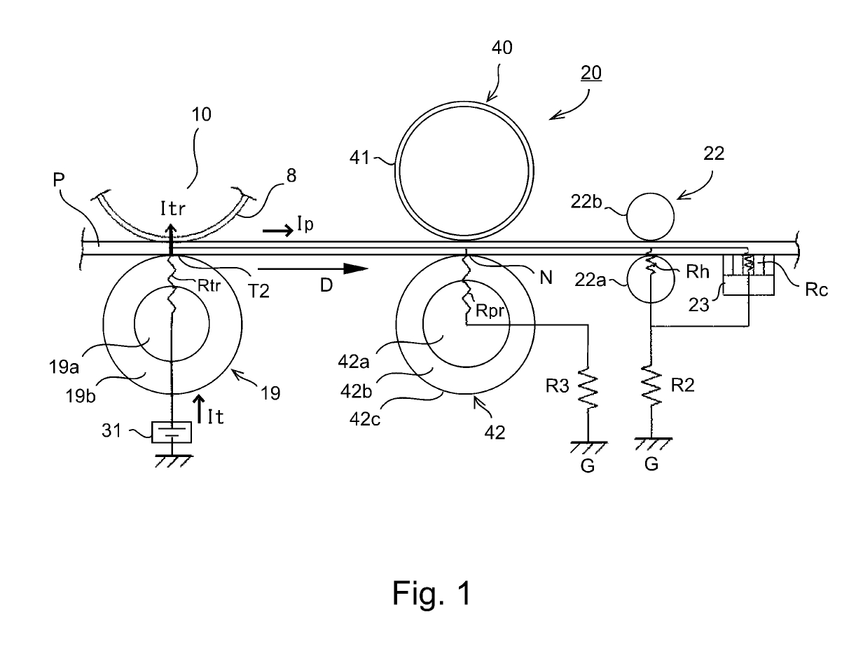

FIG. 1 is a schematic view for illustrating the action of this embodiment. A mechanism of the action will be described with reference to FIG. 1. For the purpose of easy-to-see illustration, in FIG. 1, an arrangement of the secondary transfer 19, the film unit 40, the pressing roller 42, the discharging roller pair 22, the discharging brush 23 and the like is changed.

In the high-temperature and high-humidity environment, the transfer voltage of about 500-700 V is applied from the transfer voltage source 31 to the secondary transfer roller 19. The resistance of the sheet P is low, so that the voltage drop from the secondary transfer nip T2 does not readily generate, and therefore the potential of the sheet P in the neighborhood of the discharging brush 23 becomes about 500 V which is high. On the other hand, although the discharging brush 23 itself is formed with the electroconductive member, the free end of the discharging brush 23 point-contacts the sheet P, and therefore the grounding resistor Rc has the resistance value of 1 GΩ which is large.

In a comparison example shown in FIG. 7, as described above, the discharging brush 23 is grounded (G) via the grounding resistor Rg, and therefore the voltage is shaped principally by the contact resistance portion Rc.

On the other hand, in this embodiment shown in FIG. 1, the discharging brush 23 is electrically connected with the upper sheet discharging roller 22a as the electroconductive member, and is grounded via the resistor R2.

When the electric path starting from the sheet P at the discharging roller pair 22 is considered, parallel connection between a resistor Rh in a path passing through the upper sheet discharging roller 22a and the resistor Rc in the path passing through the discharging brush 23 is established, and a combined resistance therebetween and the discharging brush R2 are connected in series. By existence of the grounding resistor R2, correspondingly to the voltage applied to the grounding resistor R2, the voltage applied to the combined resistance portion becomes small. That is, the potential difference between the sheet P and the discharging brush 23 becomes small. In order to increase the voltage applied to the grounding resistor R2, it is desirable that the grounding resistor R2 is larger in resistance value than the resistor Rh, and therefore in this embodiment, the resistor R2 in this embodiment was 500 MΩ in resistance value.

In this embodiment, compared with the contact resistance Rc, the electric resistance Rh of the upper sheet discharging roller 22a is sufficiently small, and therefore the combined resistance is substantially equal to the electric resistance Rh of the upper sheet discharging roller 22a. Further, the grounding resistor R2 is sufficiently larger in resistance value than the combined resistance, and therefore most of the voltage is applied toward the grounding resistor R2.

Therefore, in this embodiment, similarly as the sheet P, also the discharging brush 23 is held at a potential in the neighborhood of the potential of the sheet P, and therefore the potential difference is not generated between the sheet P and the discharging brush 23, and thus also the electrostatic attraction force is not generated. In this embodiment, both of the sheet P and the discharging brush 23 are held at the potential in the neighborhood of 500 V. As a result, the image defect generated by the rubbing of the sheet P with the discharging brush 23 in the operation in the double-side image forming mode can be improved. Further, in an environment such as a low-temperature and low-humidity environment in which the sheet P is electrically chargeable, a discharging power of the discharging brush 23 can be exhibited similarly as in the conventional discharging brush.

The feature and constitution of the image forming apparatus in this embodiment are summarized as follows. The transfer portion T2 where the (unfixed) toner image ta formed on the image bearing member 8 is electrostatically transferred onto the recording material P by the transfer member 19 (contact member) to which the voltage is applied is provided. The fixing device 20, which is disposed downstream of the transfer portion T2 with respect to the recording material direction D, for fixing the toner image ta, as the fixed image, transferred on the recording material P is provided. The discharging member 23, which is disposed downstream of the fixing device 20 with respect to the sheet feeding direction D, for discharging the recording material P in contact with the recording material P is provided.

In the image forming apparatus A, the length of the recording material feeding path from the transfer portion T2 (secondary transfer roller 19) to the discharging member 23 is not more than a maximum length of the recording material usable in the apparatus. Further, the electroconductive member 22a contacting the recording material P fed along the recording material feeding path from the transfer portion T2 to the discharging member 23 is provided. The discharging member 23 and the electroconductive member 22a are electrically connected in parallel to each other, and the electroconductive member 22a is grounded (G) via the resistor R2.

By the above-described constitution of the image forming apparatus, it is possible to suppress the image defect generated by the rubbing of the sheet P with the discharging brush 23 while ensuring the alignment property of the sheets P on the discharge tray 25. In this embodiment, the discharging brush 23 is used as the discharging member, but as the discharging member, another discharging member, such as a discharging cloth, of a contact type may also be used.

This embodiment is not based on the premise that the image forming apparatus having the mechanism for automatically effecting the image formation of the sheet P on the both surfaces thereof is used. This is because the problem of this embodiment can occur even when the image forming apparatus in which the image formation of the sheet P is effected only one of the surfaces of the sheet P by a user is used. For example, the problem can occur in the case where the use sets the sheet, on which the image is formed at one of the surfaces of the sheets of the sheet, in an upside down manner and then the image is formed on the other surface of the sheet.

In this embodiment, although the contact member which contacts the recording material and to which the voltage is applied is used as the secondary transfer roller 19, but the present invention is not limited thereto. Further, in this embodiment, although the upper sheet discharging roller 22a as the second electroconductive member is provided between the secondary transfer roller 19 and the discharging brush 23 with respect to the recording material feeding direction, the upper sheet discharging roller 22a may also be provided downstream of the discharging brush 23.

### Embodiment 2

In this embodiment, as the electroconductive member, the upper sheet discharging roller 22a is not used, but the pressing roller 42 of the fixing device 20 is used. That is, in this embodiment, the pressing roller 42 of the fixing device 20 also functions as the electroconductive member. A difference between this embodiment and Embodiment 1 is only electric connection of the discharging brush 23 with the pressing roller 42, and other constitutions of the image forming apparatus, the fixing device 20 and the like are the same as those in Embodiment 1 and will be omitted from redundant description.

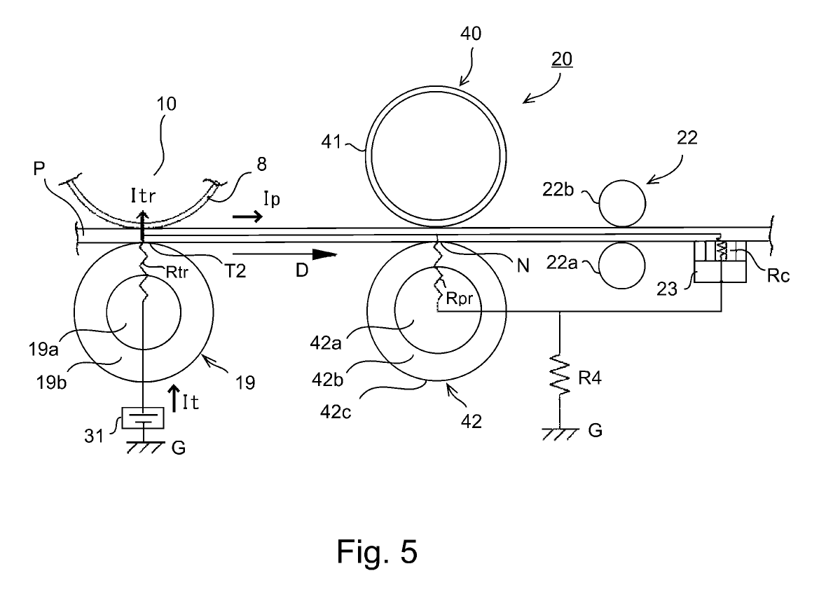

A feature of this embodiment will be described with reference to FIG. 5. In this embodiment, the core metal 42a of the pressing roller 42 as the electroconductive member of the fixing device 20 and the discharging brush 23 are electrically connected with each other and are grounded via a grounding resistor R4. The grounding resistor R4 is 1 GΩ in resistance value.

The grounding resistor R4 has the resistance value of 1 GΩ which is sufficiently larger than the resistance value (about 10 kΩ as described above in this embodiment) of the resistor Rpr, and therefore similarly as in Embodiment 1, most of the voltage is applied toward the grounding resistor R4. For that reason, the potentials of the sheet P and the discharging brush 23 are substantially equal to each other, so that the potential difference therebetween is about 0. Further, in this embodiment, the resistor R4 can be simultaneously used as the contact resistance (R3 in FIG. 1) for the pressing roller 42, and therefore even when the grounding resistor for the pressing roller 42 is not individually proved, it is possible to suppress the leak current Ip of the transfer current from the pressing roller 42.

As described above, in this embodiment, by using the pressing roller 42 as the electroconductive member, it is possible to not only suppress the image defect generated by the rubbing of the sheet P with the discharging member 23 while ensuring the alignment property of the sheets P on the discharge tray 25 but also use the resistor R4 also functioning as the grounding resistor for the pressing roller 42.

In this embodiment, the connection is established by using only the resistor, but the effect of this embodiment can be obtained by establishing parallel connection using, e.g., a capacitor in combination with the resistor.

### Embodiment 3

In this embodiment, in addition to the constitution of Embodiment 2, the discharging brush 23 and the core metal 42a of the pressing roller 42 are electrically connected with each other via a resistor (second resistor) R5. Other constitutions of the image forming apparatus, the fixing device 20 and the like are similar to those in Embodiments 1 and 2, and therefore will be omitted from redundant description.

In Embodiment 2, the discharging brush 23 was electrically directly connected with the core metal 42a of the pressing roller 42. For that reason, in the continuous double-side sheet passing in the low-temperature and low-humidity environment in which the passed sheet P is readily charged, the potential of the pressing roller 42 is affected and fluctuated by the potential of the discharging brush 23. Further, depending on the species of the sheet P, there is a possibility that electrostatic offset such that the toner is electrostatically offset onto the film 41 occurs.

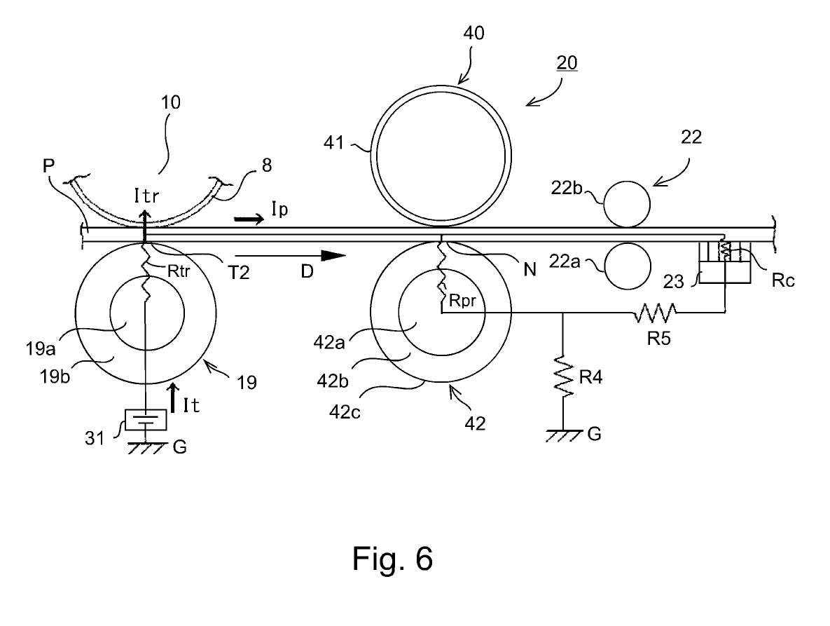

In this embodiment, as shown in FIG. 6, the discharging brush 23 and the core metal 42a of the pressing roller 42 were connected with each other via the resistor (second resistor) R5 of 1 GΩ in resistance value. As a result, even when the potential of the discharging brush 23 becomes a certain potential by the influence of the sheet P during the discharge of the sheet P by the discharging brush 23, the potential is not directly reflected in the potential of the pressing roller 42, so that the voltage is shared correspondingly to the voltage of the resistor R5 between the discharging brush 23 and the pressing roller 42. For that reason, the core metal potential of the pressing roller 42 lowers and approaches 0.

As a result, at the fixing nip N, it is possible to reduce a degree of liability of the generation of the electrostatic offset by the electrostatic attraction of the toner on the sheet P to the film 41.

As described above, in this embodiment, by decreasing a degree of the influence such that the potential of the core metal 42a of the pressing roller 42 of the fixing device 20 fluctuates by being affected by the potential of the discharging brush 23, the potential of the core metal 42a of the pressing roller 42 is caused to approach about 0. By stabilizing the potential of the pressing roller 42, it is possible to suppress the generation of the electrostatic offset or the like.

### Other Embodiments

In the above, Embodiments according to the present invention are described specifically, but the constitutions can be replaced with other known various constitutions within the scope of the concept of the present invention.

(1) The type of the image forming portion of the image forming apparatus is not limited to the electrophotographic type using the electrophotographic photosensitive member as the image bearing member. An image forming portion of an electrostatic recording type using an electrostatic recording dielectric member as the image bearing member or of a magnetic recording type using a magnetic recording (magnetic) member as the image bearing member may also be used.

(2) The type of the image forming apparatus is not limited to the intermediary transfer type. An image forming apparatus of a type in which the toner image formed on the image bearing member in the above-described manner is transferred onto the recording material without via the intermediary transfer member may also be used.

(3) The image forming apparatus is not limited to the printer, but may also be a copying machine, a facsimile machine, a multi-function machine and the like. The image forming apparatus is not limited to the color image forming apparatus, but may also be a monochromatic image forming apparatus.

(4) The transfer member constituting the transfer portion is not limited to the transfer roller. Another contact transfer member such as a transfer blade and a non-contact transfer member such as a corona discharger may also be used.

(5) The fixing device for fixing, as the fixed image, the (unfixed) toner image transferred on the recording material is not limited to the heat-fixing device of the fixing type in the above-described embodiments, but may also be a heat-fixing device of a roller fixing type using a roller pair or a heat-fixing device of a hot plate type or a heat chamber type. As a heat source or a heating means, it is possible to appropriately use a ceramic heater, a halogen heater, an infrared lamp, an electromagnetic induction coil or the like. Further, the fixing device may also be a fixing device of a pressure fixing type using a pressure roller pair.

(6) In the case where the fixing device includes the first and second members constituting the fixing nip, where the first member contacts the (unfixed) toner image-carrying surface of the recording material and the second member contacts the opposite surface, and where the first member is a rotatable member to be rotationally driven, the second member may also be a non-rotatable member. The second member may also be formed in a non-rotatable member shape, such as a pad or a plate-like member, having a small friction coefficient at the surface which is the contact surface with the first member or the recording material.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 256851/2013 filed Dec. 12, 2013, which is hereby incorporated by reference.

What is claimed is:

1. An image forming apparatus for forming an image on a recording material, comprising:
a contact member, contacting the recording material, to which a voltage is to be applied;
a first electroconductive member contacting the recording material downstream of said contact member with respect to a recording material feeding direction, wherein said first electroconductive member is grounded; and
a second electroconductive member contacting the recording material,
wherein a distance between said contact member and said first electroconductive member is not more than a length of a longest recording material capable of being fed by said image forming apparatus,
wherein a contact resistance between said second electroconductive member and the recording material is smaller than a contact resistance between said first electroconductive member and the recording material; and
wherein said first electroconductive member and said second electroconductive member are electrically connected in parallel to each other.

2. The apparatus according to claim 1, further comprising an image bearing member for bearing the toner image,
wherein said contact member is a transfer member for transferring the toner image from said image bearing member onto the recording material.

3. The apparatus according to claim 1, wherein said second electroconductive member is provided between said contact member and said first electroconductive member with respect to the recording material feeding direction.

4. The apparatus according to claim 1, wherein said first electroconductive member is a brush.

5. The apparatus according to claim 1, wherein a portion where said first and second electroconductive members are electrically connected in parallel to each other is grounded via a resistor.

6. The apparatus according to claim 4, wherein a resistance of the resistor is larger than a contact resistance of between said electroconductive member and the recording material.

7. The apparatus according to claim 1, wherein said second electroconductive member is a roller.

8. The apparatus according to claim 7, further comprising a fixing portion for fixing the toner image no the recording material,
wherein said roller is provided downstream of said fixing portion with respect to the recording material feeding direction, and forms a nip for this embodiment the recording material.

9. The apparatus according to claim 7, further comprising a fixing portion for fixing the toner image on the recording material,
wherein said roller from a nip at said fixing portion.

10. An image forming apparatus for forming an image on a recording material, comprising:
a contact member, contacting the recording material, to which a voltage is to be applied;
a discharging brush contacting the recording material downstream of said contact member with respect to a recording material feeding direction, wherein said discharging brush is grounded; and
a roller contacting the recording material,
wherein a distance between said contact member and said is not more than a length of a longest recording material capable of being fed by said image forming apparatus, and
wherein said discharging brush and said roller are electrically connected in parallel to each other.

11. The apparatus according to claim 10, further comprising an image bearing member for bearing the toner image,
wherein said contact member is a transfer member for transferring the toner image from said image bearing member onto the recording material.

12. The apparatus according to claim 10, wherein said roller is provided between said contact member and said discharging brush with respect to the recording material feeding direction.

13. The apparatus according to claim 10, wherein a portion where said discharging brush and said roller are electrically connected in parallel to each other is grounded via a resistor.

14. The apparatus according to claim 13, wherein a resistance of the resistor is larger than a contact resistance of between said roller and the recording material.

15. The apparatus according to claim 10, further comprising a fixing portion for fixing the toner image no the recording material,
wherein said roller is provided downstream of said fixing portion with respect to the recording material feeding direction, and forms a nip for this embodiment the recording material.

16. The apparatus according to claim 10, further comprising a fixing portion for fixing the toner image on the recording material,
wherein said roller from a nip at said fixing portion.
